(19) United States
(12) Patent Application Publication
(10) Pub. No.: US 2016/0059674 A1
(43) Pub. Date: Mar. 3, 2016

(54) TELEMATICS TERMINAL FOR PURIFYING AIR INSIDE VEHICLE AND METHOD FOR CONTROLLING THE SAME

(71) Applicant: Kia Motors Corporation, Seoul (KR)

(72) Inventors: Jun Tae Kim, Seoul (KR); Min Ju Kim, Yongin, Gyeonngi-do (KR); Ja Ho Koo, Seoul (KR); Jae Won Chang, Seoul (KR)

(21) Appl. No.: 14/569,651

(22) Filed: Dec. 13, 2014

(30) Foreign Application Priority Data
Aug. 26, 2014 (KR) 10-2014-0111430

(51) Int. Cl. B60H 3/00; B60K 35/00

(52) U.S. Cl. CPC B60H 3/0085; B60K 35/00

(57) ABSTRACT

A telematics terminal is provided. The telematics terminal includes a communication unit that is configured to receive weather information from a telematics center and a display unit that is configured to display the received weather information. In addition, a controller is configured to executed at least one item for triggering a function of purifying air inside a vehicle to be displayed when the weather information does not meet a predetermined air pollution standard.

### CROSS REFERENCE TO RELATED APPLICATION(S)

This application claims the benefit of Korean Patent Application No. 10-2014-0111430, filed on Aug. 26, 2014, which is hereby incorporated by reference as if fully set forth herein.

### BACKGROUND

1. Field of the Invention

The present invention relates to a telematics terminal for purifying air inside a vehicle and a method for controlling the same and, more specifically, to a telematics terminal for receiving weather information and purifying air inside a vehicle based on the weather information and a method for controlling the same.

2. Discussion of the Related Art

With the rapid advances in electronic control, various devices for automobiles, which were conventionally operated based on a mechanical method, are driven by an electronic method for driver convenience and running stability and automobile systems are enhanced and advanced. Particularly, telematics technology has remarkably developed. Telematics is a wireless data service which provides information during movement of transportation means and enables information exchange using computers set in transportation means such as vehicles, planes, ships and the like, radio communication technology, global positioning systems, techniques of changing a text signal and an audio signal on the Internet, etc. The compound word “telematics” is formed from the words “telecommunication” and “informatics.” Telematics refers to a system which is configured to analyze types of phenomena generated within a vehicle and to collect various types of information necessary for driving through a communication terminal installed within the vehicle to enable convenient and safe driving.

To be provided with the telematics service, a vehicle needs to be equipped with a global positioning system (GPS) and a telematics terminal having a mobile communication function. The telematics service provides information regarding vehicle accidents, theft detection, running route guide and the like, traffic and living information, games, etc. to drivers by combining mobile communication technology and location-tracking technology. In addition, a user may have to drive a vehicle in bad weather, for example, when the concentration of fine dust is high, in snow or rain, or during high winds. Accordingly, the user may safely drive when the vehicle provides, the user with weather information and driving suggestions based on the weather information.

### SUMMARY

An object of the present invention provides an item which triggers purification of air inside a vehicle and a method for controlling the same. The technical problems solved by the present invention are not limited to the above technical problems and those skilled in the art may understand other technical problems from the following description.

In an aspect of the present invention, a method for controlling a telematics terminal may include: receiving weather information from a telematics center; displaying the received weather information; and displaying at least one item for triggering a function of purifying air inside a vehicle when the weather information does not meet a predetermined air pollution standard.

The method may further include automatically transmitting a signal for receiving the weather information to the telematics center at a specific time after the telematics terminal is turned on and operating an air purifier to execute a vehicle air purification function that corresponds to the at least one item for triggering the function of purifying air inside the vehicle upon selection of the at least one item. The item may include at least one of an item for executing an internal air switch function, an air-conditioning function, and an air volume control function.

The displaying of the at least one item may include displaying an item for warning a user when the weather information does not meet the predetermined air pollution standard. Additionally, the method may include displaying driving guide information when the item for warning the user is displayed and the item for warning the user is selected through a user input. The method may further include: setting information regarding a destination based on user input; and transmitting the destination information to the telematics center, wherein the receiving of the weather information from the telematics center may include receiving the weather information in real time during movement to the destination. The method may further include transmitting the weather information to a registered mobile terminal when the weather information does not meet the predetermined air pollution standard.

In an aspect of the present invention, a telematics terminal may include: a communication unit configured to receive weather information from a telematics center; a display unit configured to display the received weather information; and a controller configured to execute at least one item for triggering a function of purifying air inside a vehicle to be displayed when the weather information does not meet a predetermined air pollution standard.

The controller may be configured to operate the communication unit to automatically transmit a signal for receiving the weather information to the telematics center at a specific time after the telematics terminal is turned on. When the at least one item is selected, the controller may be configured to operate an air purifier to execute a vehicle air purification function that corresponds to the selected item. The item may include at least one of an item for executing an internal air switch function, an air-conditioning function, and an air volume control function.

The controller may further be configured to operate the display unit to display an item for warning a user when the weather information does not meet the predetermined air pollution standard. The controller may further be configured to display driving guide information when the weather information does not meet the predetermined air pollution standard and the item for warning the user is selected. In addition, the controller may be configured to set information regarding a destination based on the user input, to transmit the destination information to the telematics center and to provide the weather information, transmitted in real time, to the user in real time when the weather information is provided by the telematics center in real time during movement to the destination. The controller may further be configured to transmit the weather information to a registered mobile terminal when the weather information does not meet the predetermined air pollution standard.

In an aspect of the present invention, a non-transitory recording medium configured to store a program for executing a method for operating a telematics terminal, the method for controlling the telematics terminal may include: receiving weather information from a telematics center; displaying the received weather information; and displaying at least one item for triggering a function of purifying air inside a vehicle when the weather information does not meet a predetermined air pollution standard.

According to the aforementioned embodiments of the present invention, the telematics terminal for purification of air inside a vehicle may improve user convenience and support health maintenance of the user. The effects of the present invention are not limited to the above-described effects and other effects which are not described herein will become apparent to those skilled in the art from the following description.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is an exemplary diagram of a network including a telematics terminal according to an exemplary embodiment of the present invention;

FIG. 2 is an exemplary block diagram of a telematics terminal according to an exemplary embodiment of the present invention;

FIG. 3 is an exemplary flowchart illustrating a method for controlling a telematics terminal which purifies the inside of a vehicle according to an exemplary embodiment of the present invention;

FIG. 4 illustrates an exemplary telematics terminal which provides weather information according to an exemplary embodiment of the present invention;

FIGS. 5A-5B, 6A-6B, and 7A-7B illustrate an exemplary embodiment of providing operation guides of the telematics terminal when weather information is displayed according to an exemplary embodiment of the present invention; and

FIG. 8 illustrates an exemplary telematics terminal which provides weather information to a mobile terminal according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Reference will now be made in detail to the exemplary embodiments of the present invention, examples of which are illustrated in the accompanying drawings. Wherever possible, the same reference numbers will be used throughout the drawings to refer to the same or like parts. Although the suffix “module” or “unit” is used for constituent elements described in the following description, this is intended only for easy description of the specification. Furthermore, a detailed description of known functions and configurations incorporated herein will be omitted when it may obscure the subject matter of the present invention. Specific exemplary embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

In the meantime, although terms including an ordinal number, such as first or second, may be used to describe a variety of constituent elements, the constituent elements are not limited by the terms, and the terms are used only for the purpose of discriminating one constituent element from other constituent elements.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements. The singular forms are intended to include the plural forms as well, unless the context clearly indicates otherwise. It will be further understood that the terms “comprises” or “includes” when used in this specification, specify the presence of stated features, regions, integers, steps, operations, elements, and/or components, but do not preclude the presence or addition of one or more other features, regions, integers, steps, operations, elements, components, and/or groups thereof.

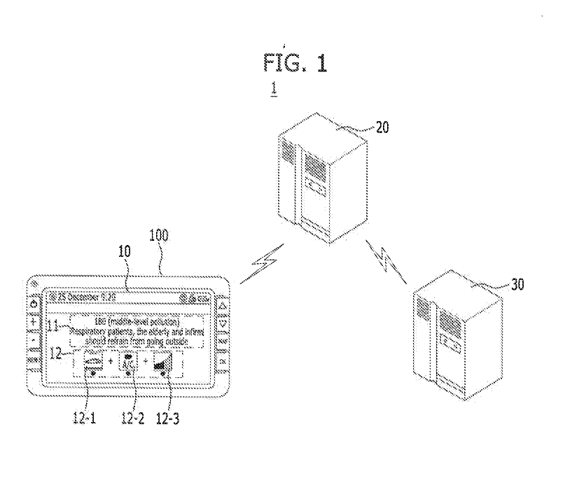

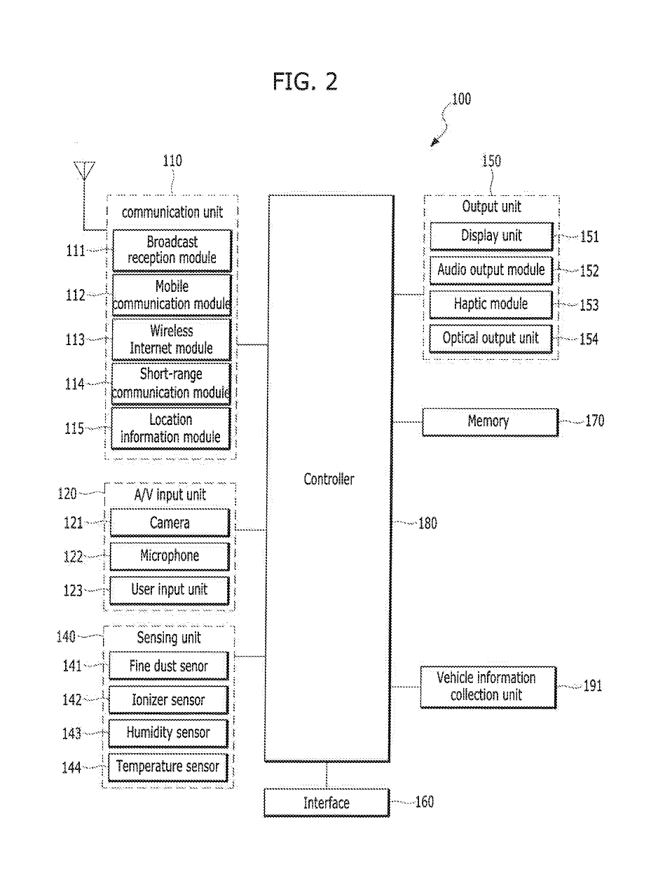

FIG. 1 is an exemplary diagram of a network including a telematics terminal according to an exemplary embodiment of the present invention. Referring to FIG. 1, a network 1 may include a telematics terminal 100, a telematics center 20 and a weather provider. The telematics terminal 100 may include a mobile communication modem and may be configured to perform wireless communication with the telematics center 20. The telematics terminal 100 may be mounted within a vehicle. A detailed configuration of the telematics terminal 100 will be described with reference to FIG. 2.

The telematics center 20 may be wirelessly connected to the telematics terminal 100 and provide various services. For example, the telematics center 20 may provide a vehicle accident service, robbery protection service, driving route guide service, traffic and living information service, game service and the like. The telematics center 20 may be connected to various content providers in a wired or wireless manner and provide content to the telematics terminal 100. In particular, the telematics center 20 may be configured to receive weather information from a weather content provider, one of the content providers, and transmit the weather information to the telematics terminal 100.

The telematics terminal 100 may further be configured to display the weather information (not shown) on a display 10 disposed within the telematics terminal 100. For example, the display 10 may be configured to display information such as daily weather, weather of the current location of the corresponding vehicle, a degree of air pollution, humidity, temperature and the like. In addition, the telematics terminal 100 may be configured to search for a destination through user input (e.g. touch input) and receive, from the telematics center 20, weather information of the destination, weather information of a route from the current location of the vehicle to the destination and the like. In particular, when weather information received from the telematics center 20 does not meet a predetermined air pollution standard, the telematics terminal 100 may be configured to display the weather information. For example, the telematics terminal 100 may be configured to display warning notice 11 such as “180 (middle-level pollution) respiratory patients should refrain from going outside.”

Furthermore, the telematics terminal 100 may be configured to display a menu 12 by which an air conditioning apparatus for adjusting air within the vehicle may be adjusted. For example, the telematics terminal 100 may be configured to display a vehicle inside air change menu 12-1, an air-conditioner operation menu 12-2 and an air volume control menu 12-3. The menus 12-1, 12-2 and 12-3 may be selected by a user (user touch input). In particular, a menu selected by user touch input may be activated and displayed. Specifically, an light emitting diode (LED) lamp provided to a portion of the corresponding menu may be turned on. In addition, activation of the corresponding menu may be recognized by the user visually, auditorily or olfactorily in various manners.

The telematics terminal 100 may be configured to operate the air conditioning apparatus upon selection of the menus 12-1, 12-2 and 12-3 by which the air conditioning apparatus may be operated according to user touch input. Specifically, the telematics terminal 100 may be configured to request a controller of the vehicle to execute an air control function selected by user touch input or directly operate the air conditioning apparatus. While the telematics terminal 100 is set in the vehicle 100 in the specification, this is exemplary and the telematics terminal 100 may be mounted in various apparatuses or operated in a stand-alone way.

FIG. 2 is an exemplary block diagram of the telematics terminal 100 according to an exemplary embodiment of the present invention. The telematics terminal 100 may include a communication unit 110, an A/V input unit 120, a sensing unit 140, an output unit 150, an interface 160, a memory 170, a controller 180, and a vehicle information collection unit 191. Since the components shown in FIG. 2 are not essential to implement the telematics terminal, the telematics terminal described in the specification may include a larger or smaller number of components than the aforementioned components. The controller 180 may be configured to operate the various units of the telematics terminal.

More specifically, the communication unit 110 may include one or more modules that enable radio communication between the telematics terminal 100 and a radio communication system, between the telematics terminal 100 and another telematics terminal 100 or between the telematics terminal 100 and an external server. In addition, the communication unit 110 may include one or more modules for connecting the telematics terminal 100 to one or more networks.

The communication unit 110 may include at least one of a broadcast reception module 111, a mobile communication module 112, a wireless Internet module 113, a short-range communication module 114 and a location information module 115. The input unit 120 may include an imaging device 121 (e.g., a camera, video camera, or the like) or a video input unit for video signal input, a microphone 122 or an audio input unit for audio signal input and a user input unit 123 (e.g. touch key, mechanical key or the like) for receiving information from the user. Audio data or image data collected by the input unit 120 may be analyzed and processed into a control command of the user.

The sensing unit 140 may include one or more sensors configured to sense at least one of information on the telematics terminal, information regarding the surrounding environment of the telematics terminal and user information. For example, the sensing unit 140 may include at least one of a fine dust sensor 141, an ionizer sensor 142, a humidity sensor 143, a temperature sensor 144, a radioactivity sensor, a heat sensor, a gas sensor, an electronic nose, a healthcare sensor, a bio sensor, a proximity sensor, an illumination sensor, a touch sensor, an acceleration sensor, a magnetic sensor, a G-sensor, a gyroscope sensor, a motion sensor, an red-green-blue (RGB) sensor, an infrared (IR) sensor, a fingerprint scan sensor, an ultrasonic sensor, an optical sensor (e.g. camera 121), a microphone 122, and a battery gauge. The telematics terminal disclosed in the specification may combine information sensed by at least two of these sensors and use the combined information.

The output unit 150 may be configured to generate a visual, auditory or haptic output and may include at least one of a display unit 151, an audio output unit 152 a haptic module 153 and an optical output unit 154. The display unit 151 may form a layered structure with a touch sensor or be integrated with the touch sensor to implement a touchscreen. The touchscreen may function as the user input unit 123, which provides an input interface between the telematics terminal 100 and the user, and simultaneously provides an output interface between the telematics terminal 100 and the user.

The interface 160 functions as a path to various external devices connected to the telematics terminal 100. The interface 160 may include at least one of a wired/wireless headset port, an external charger port, a wired/wireless data port, a memory card port, a port for connecting a device including an identification module, an audio input/output (I/O) port, a video I/O port and an earphone port. The telematics terminal 100 may be configured to perform appropriate control with respect to an external terminal upon connection of the external device to the interface 160.

Particularly, the interface 160 may be connected to the controller 180 to execute various functions within the vehicle. The memory 170 may be executed by the controller 180 to store data supporting functions of the telematics terminal 100. In addition, the memory 170 may be configured to store application programs (or applications) executed in the telematics terminal 100, data and commands for operations of the telematics terminal 100. At least some application programs may be downloaded from an external server via radio communication. Furthermore, at least some application programs may be installed in the telematics terminal 100 when providing basic functions (e.g. incoming call, outgoing call, message reception and message transmission) of the telematics terminal 100. Application programs may be stored in the memory 170, installed within the telematics terminal 100 and executed to perform operations (or functions) of the telematics terminal 100.

The controller 180 may be configured to execute overall operations of the telematics terminal 100 in addition to operations related to the application programs. The controller 180 may further be configured to process signals, data, information and the like, which are input or output through the aforementioned components, or execute the application programs stored in the memory 170 to provide appropriate information or functions to the user or process the information or functions. In addition, the controller 180 may be configured to operate at least some of the components described with reference to FIG. 1A to execute application programs stored in the memory 170. Furthermore, the controller 180 may be configured to operate at least two of the components included in the telematics terminal 100 in a combined manner to execute the application programs.

A detailed description will be given of the aforementioned components with reference to FIG. 2 prior to description of various exemplary embodiments implemented through the telematics terminal 100. The communication unit 100 will now be described first. The broadcast reception module of the communication unit 110 may be configured to receive a broadcast signal and/or broadcast related information from an external broadcast management server via a broadcast channel.

The mobile communication module 112 may be configured to transmit and receive radio signals to and from at least one of a base station, an external terminal and a server via a mobile communication network which is constructed according to technical standards or communication schemes for mobile communications (e.g. GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), LTE-A (Long Term Evolution-Advanced) and the like). The radio signals may include a voice call signal, a video call signal and various types of data according to text/multimedia message transmission and reception.

The mobile communication module 112 may be connected to a user terminal (not shown) using the mobile communication network. The wireless Internet module 113 refers to a module for wireless Internet access and may be included within the telematics terminal 100 or provided extraneous to the telematics terminal 100. The wireless Internet module 113 may be configured to transmit and receive radio signals in a communication network according to wireless Internet. Wireless Internet includes WLAN (Wireless LAN), Wi-Fi (Wireless-Fidelity), Wi-Fi (Wireless Fidelity) Direct, DLNA (Digital Living Network Alliance), WiBro (Wireless Broadband), WiMAX (World Interoperability for Microwave Access), HSDPA (High Speed Downlink Packet Access), HSUPA (High Speed Uplink Packet Access), LTE (Long Term Evolution), LTE-A (Long Term Evolution-Advanced), etc. The wireless Internet module 113 may be configured to transmit and receive data according to at least one wireless Internet technology.

Since wireless Internet access according to WiBro, HSDPA, HSUPA, GSM, CDMA, WCDMA, LTE, LTE-A and the like may be performed via a mobile communication network, the wireless Internet module 113 which performs wireless Internet access via the mobile communication network may be understood as a type of the mobile communication module 112. The short-range communication module 114 may support short-range communication using at least one of Bluetooth™, RFID (Radio Frequency Identification), IrDA (Infrared Data Association), UWB (Ultra Wideband), ZigBee, NFC (Near Field Communication), Wi-Fi (Wireless-Fidelity), Wi-Fi Direct and Wireless USB (Wireless Universal Serial Bus). The short-range communication module 114 may support radio communication between the telematics terminal 100 and a radio communication system, between the telematics terminal 100 and another telematics terminal or between the telematics terminal 100 and a network connected to another telematics terminal 100 (or an external server) via wireless area networks. The wireless area networks may be wireless personal area networks.

The location information module 115 may be used to detect the location (or current position) of the telematics terminal and may include a GPS or WiFi (Wireless Fidelity) module. For example, the telematics terminal may be configured to acquire information regarding the location thereof using a signal transmitted from a GPS satellite using the GPS module. The telematics terminal may be configured to detect the location thereof using the WiFi module based on the information of a wireless access point (AP) which transmits and receives radio signals to and from the WiFi module. The location information module 115 may be configured to execute a function of another module of the communication unit 110 to acquire data regarding the location thereof alternatively or additionally. The location information module 115 may be used to detect the location (or current position) of the telematics terminal and is not limited to a module which directly calculates or acquires the location of the telematics terminal.

Operation Principle of Telematics Terminal for Vehicle Air Purification

A description will be given of the operation principle of the telematics terminal for vehicle air purification. The telematics terminal 100 may be configured to receive weather information from the telematics center 20 (S310). Specifically, the telematics terminal 100 may be configured to wirelessly receive weather information from the telematics center 20 via the communication unit 110. The telematics terminal 100 may be configured to receive weather information at the request of the telematics terminal 100. In particular, the telematics terminal 100 may be configured to automatically transmit a signal to receive the weather information to the telematics center 20 at a specific time after being turned on. While the telematics terminal 100 receives the weather information when turned on in the present exemplary embodiment, the telematics terminal 100 may be configured to receive weather information before being turned on while operating with substantially (low power.

The signal may be manually transmitted by the user to the telematics center 20. For example, when the user inputs an area to be searched for (e.g., a search request input) and a destination to the telematics terminal 100, weather information regarding the area and destination may be transmitted from the telematics center 20 to the telematics terminal 100. The telematics terminal 100 may be configured to directly receive weather information from an external server, a terminal and a service provider via the broadcast communication module 111, the mobile communication module 112, the wireless Internet module 113, the short-range communication module 114 and the location information module 115. Furthermore, the telematics terminal 100 may be configured to receive weather information via an SNS server in real time.

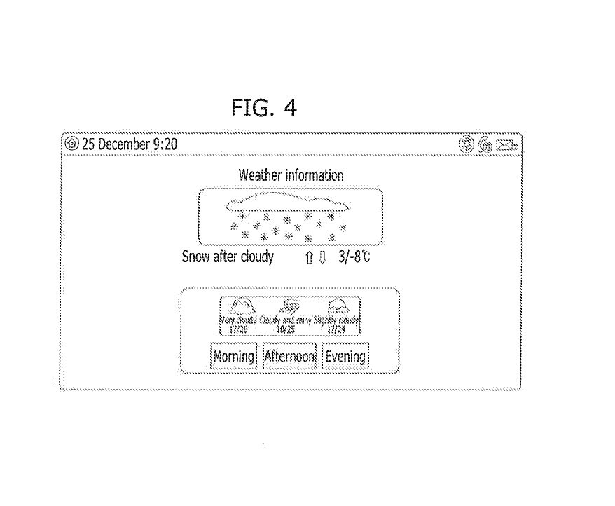

The telematics terminal 100 may be configured to display the received weather information (S320). For example, when the telematics terminal 100 receives weather information regarding the area where the vehicle equipped with the telematics terminal 100 is located, the controller 180 may be configured to display, through the display unit 151, information such as the weather, fine dust concentration, temperature, humidity and atmospheric pressure of the area. An example is shown in FIG. 4.

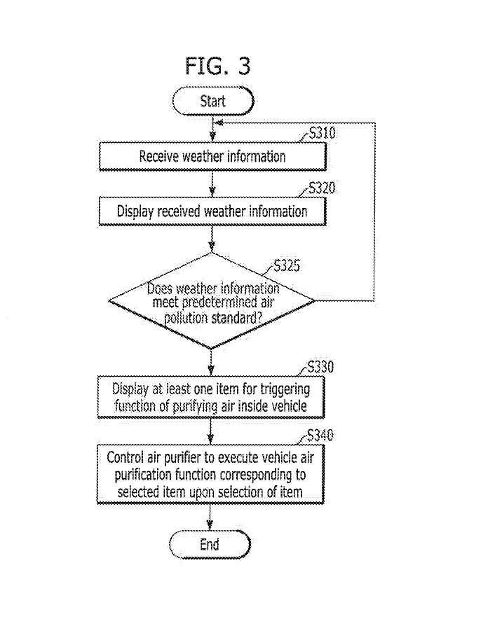

As shown in FIG. 4, the controller 180 may be configured to receive weather information regarding a specific area (e.g. the current location of the vehicle, input destination or the like) from the telematics center 20 and display the weather information on the display unit 151. Referring back to FIG. 3, the telematics terminal 100 may be configured to display at least one item for triggering a function of purifying air inside the vehicle (S330) when the weather information does not meet a predetermined air pollution standard (S325). An example of step S330 corresponds to the display of the telematics terminal 100 shown in FIG. 1.

The predetermined air pollution standard may be set by the telematics terminal 100 or received from the telematics center 20. In FIG. 1, “180” indicates atmospheric particulate matter concentration 11 around the vehicle. When the telematics terminal 100 sets the air pollution standard to 150, the case shown in FIG. 1 may be considered to exceed the predetermined air pollution standard. The telematics terminal 100 may be configured to set an appropriate standard based on the type of pollutant and adjust air inside the vehicle. For example, according to medical research, fine dust may cause a problem for sensitive people when a pollution index exceeds 200 and even for non-sensitive people when the pollution index exceeds 500. Accordingly, it is necessary to set an appropriate air pollution standard.

Furthermore, for purification of air inside the vehicle, which is polluted due to fine dust, the telematics terminal 100 may adjust the air inside the vehicle to be unpolluted and clean using an internal air switch function, an air-conditioning function, and a function of adjusting air volume to a specific level. The internal air switch function refers to a function of circulating air inside the vehicle, the air-conditioning function refers to a function of providing cold air, and the air volume control function refers to a function of controlling wind strength. The vehicle may be maintained pleasant (e.g., substantially unpolluted) using the internal air switch function, the air-conditioning function, and the function of adjusting air volume to a specific level. In particular, the telematics terminal 100 may be configured to display items 12-1, 12-2 and 12-3 respectively corresponding to the internal air switch function, the air-conditioning function, and the function of adjusting air volume to a specific level. The items 12-1, 12-2 and 12-3 may be executed when selected.

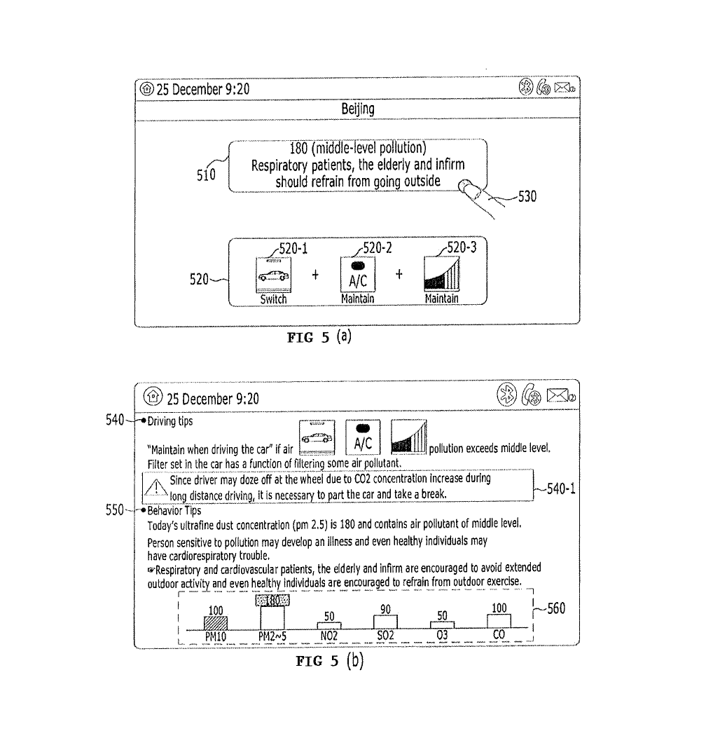

An application including the items for triggering the aforementioned functions of circulating air inside the vehicle may be implemented. This application may be downloaded from an application market or a download center. FIGS. 5A to 7B illustrate an exemplary be configured embodiment of providing operation guides of the telematics terminal when weather information is displayed. FIGS. 5A and 5B show an operation of the telematics terminal when the concentration of fine dust does not meet a predetermined air pollution standard.

Referring to FIG. 5A, the telematics terminal 100 may be configured to receive weather information from a weather content provider, one of content providers, via the telematics center 20 and display the weather information on the display unit 151. In particular, the controller 180 may be configured to display items 510, 520-1, 520-2 and 520-3 on the display unit 151. The items 510, 520-1, 520-2 and 520-3 may be selected by user input. The items 510, 520-1, 520-2 and 520-3 may be highlighted when selected by user input (e.g. touch input). The controller 180 may be configured to display the item 510 that provides a warning when the received weather information does not meet the predetermined air pollution standard.

Specifically, a middle degree of fine dust may be measured. For the middle-level pollution index, sensitive people may have bronchial trouble and even healthy people may feel uncomfortable. When the fine dust pollution index is greater than a middle level, the controller 180 may be configured to display the warning item 510. When the warning item 510 is selected through user input 530 (e.g. user touch input), the controller 180 may be configured to provide driver guide information as shown in FIG. 5B. The driver guide information may display driving tips 540 (e.g., driving suggestions) which may include a warning message 540-1.

Furthermore, the driver guide information may provide recommended behavior tips 550 (e.g., suggestions) for passengers of the vehicle. The controller 180 may be configured to display pollution level 180 of ultrafine dust concentration (e.g., PM 2.5) and provide concentrations of other pollutants (PM10, NO2, SO2, O3, CO) to the user in real time. Accordingly, vehicle passengers and a driver may set a destination based on the driver guide information and travel to a desired place using weather information. The controller 180 may be configured to set a destination based on user input. In particular, the location of the destination may be automatically input via a GPS receiver. The controller 180 may be configured to transmit information regarding the set destination to the telematics center 20. When the telematics terminal is directly connected to an external content provider via the mobile communication module 112 and the wireless Internet module 113, the telematics terminal 100 may be connected to the external content provider without passing through the telematics center 20.

In addition, the controller 180 may be configured to receive weather information from the telematics center 20 via the communication unit in real time while moving to (e.g. while traveling towards) the destination. Particularly, the controller 180 may be configured to display the weather information, which is received in real time, in real time. In addition, when the weather information received in real time does not meet the predetermined air pollution standard, the controller 180 may be configured to display the items 520-1, 520-2 and 520-3 for triggering the function of purifying air inside the vehicle. The triggering items 520-1, 520-2 and 520-3 may be activated through user input and may be displayed on the display unit. When the triggering items 520-1, 520-2 and 520-3 are selected through user input (e.g. user touch input), the controller 180 may be configured to adjust display forms, shapes, colors, brightness and the like of the items.

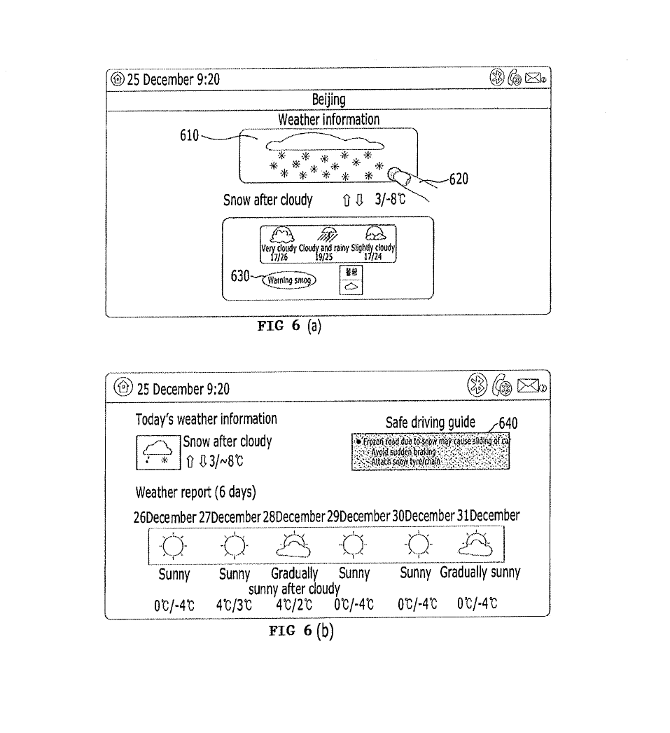

FIGS. 6A and 6B illustrate an exemplary operation of the telematics terminal when weather information is received. Referring to FIG. 6A, the controller 180 may be configured to display an item for warning the user (e.g. snow warning 610). In addition, the controller 180 may be configured to display an item for smog warning. When the item 610 for warning is selected, the controller 180 may be configured to display a screen as shown in FIG. 6B. Particularly, the controller 180 may be configured to provide driving guide information 640. In other words, the controller 180 may be configured to provide driving guide information such as prevention of sudden braking due to snow, attachment of snow tire/chain and the like.

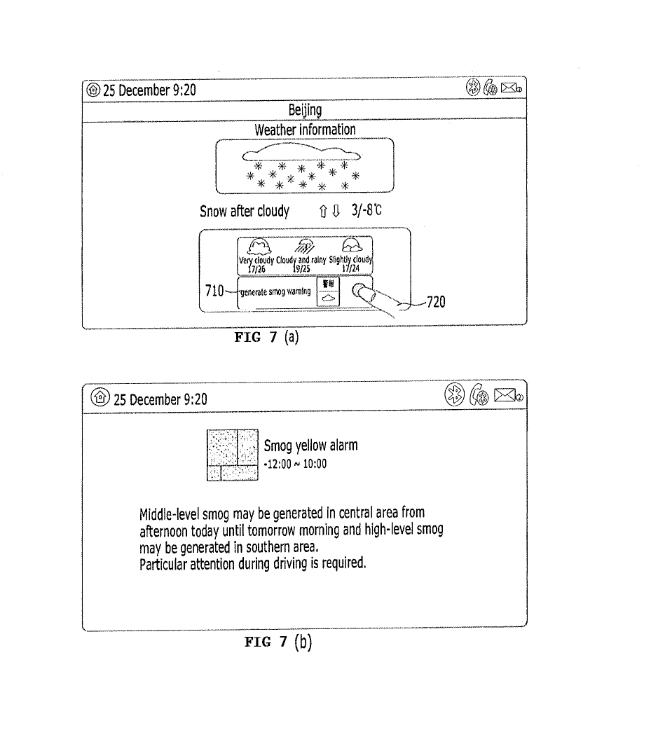

The controller 180 may be configured to generate the driving guide information 640 that corresponds to the item 610 for providing a warning and display the driving guide information 640 through the display unit 151. The aforementioned weather information may be received in real time and displayed through the display unit 151 in real time while the vehicle travels toward the destination. When a warning item 710 (e.g., smog warning generation) is selected 720, as shown in FIG. 7A, driving guide information as shown in FIG. 7B may be provided to the user. In particular, the controller 180 may be configured to operate the telematics terminal 100 to allow the user to recognize the corresponding information auditorily as well as visually. For example, the controller 180 may be configured to provide the driving guide information by voice through a speaker. Additionally, the controller 180 may be provide the driving guide information through an alarm.

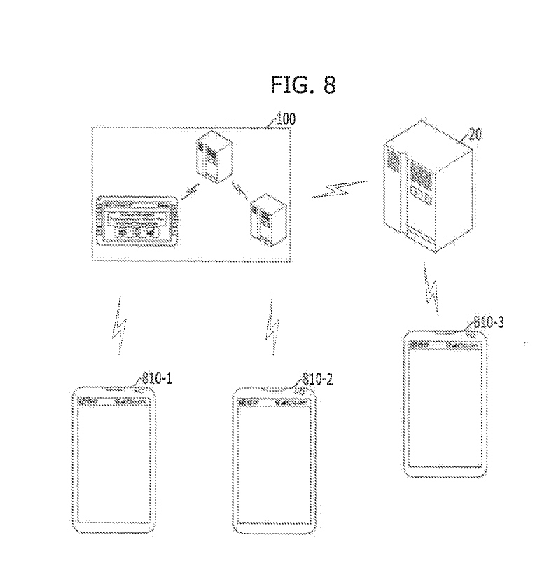

FIG. 8 illustrates an operation of the telematics terminal 100 which provides weather information to a mobile terminal according to an exemplary embodiment of the present invention. Referring to FIG. 8, the controller 180 may be configured to transmit weather information to a registered mobile terminal when the weather information meets the predetermined air pollution standard. The controller 180 may further be configured to store phone numbers of mobile terminals 810-1 and 810-2 related to the telematics terminal 100. The controller 180 may be configured to transmit current weather information to the mobile terminals 810-1 and 810-2 with phone numbers stored therein. Specifically, the controller 180 may be configured to transmit the weather information as a message including SMS, MMS or the like to the registered mobile terminals 810-1 and 810-2 via the communication unit 110 or transmit the weather information as a push message to the mobile terminals.

The telematics center 20 may be configured to directly provide weather information to a mobile terminal 810-3 without passing through the telematics terminal 100. In particular, the telematics center 20 may be configured to receive weather information from an external content provider and transmit the received weather information to the mobile terminal 810-3. The telematics center 20 may be configured to provide the weather information and behavior tips (e.g., suggestions) that correspond to the weather information to the mobile terminal 810-3.

The method for controlling the telematics terminal according to the aforementioned exemplary embodiments may be implemented as software and installed in a color calibration device. While the telematics terminal executes the air-conditioning control function in the specification, a smartphone may execute the air-conditioning control function and a displayed screen of the smartphone may be mirrored to an audio-video-navigation (AVN) screen of the vehicle.

Specifically, according to one exemplary embodiment of the present invention, the method for controlling the telematics terminal may be implemented as a non-transitory computer readable medium configured to store a program which performs the steps of receiving weather information from the telematics center, displaying the received weather information, and displaying at least one item for triggering at least one function of purifying air inside the vehicle when the weather information does not meet a predetermined air pollution standard. The non-transitory computer readable medium refers to a medium which semipermanently stores data and is readable by a device, distinguished from a medium storing data for a short time, such as a register, cache, memory and the like. Specifically, the aforementioned middleware and programs may be stored in the non-transitory computer readable medium such as a CD, DVD, hard disc, Blu-ray disc, USB, memory card and ROM.

Although exemplary aspects of the present invention have been described for illustrative purposes, those skilled in the art will appreciate that various modifications, additions and substitutions are possible, without departing from essential characteristics of the invention. Thus, embodiments disclosed herein are exemplary only and not to be considered as a limitation of the invention. Accordingly, the scope of the invention is not to be limited by the above aspects but by the claims and the equivalents thereof.

What is claimed is:

1. A method for controlling a telematics terminal, comprising:
receiving, by a controller, weather information from a telematics center;
displaying, by the controller, the received weather information; and
displaying, by the controller, at least one item for triggering a function of purifying air inside a vehicle when the weather information does not meet a predetermined air pollution standard.

2. The method according to claim 1, further comprising:
automatically transmitting, by the controller, a signal to receive the weather information to the telematics center at a specific time after the telematics terminal is turned on.

3. The method according to claim 1, further comprising:
operating, by the controller, an air purifier to execute a vehicle air purification function that corresponds to the at least one item for triggering the function of purifying air inside the vehicle upon selection of the at least one item.

4. The method according to claim 3, wherein the item includes at least one of the group consisting of: an item for executing an internal air switch function, an item for executing an air-conditioning function, and an item for executing an air volume control function.

5. The method according to claim 1, wherein the displaying of the at least one item includes:
displaying, by the controller, an item that provides warning to a user when the weather information does not meet the predetermined air pollution standard.

6. The method according to claim 5, further comprising:
displaying, by the controller, driving guide information when the item that provides a warning to the user is displayed and the item for warning the user is selected through user input.

7. The method according to claim 1, further comprising:
setting, by the controller, information regarding a destination based on user input; and
transmitting, by the controller, the destination information to the telematics center,
wherein the receiving of the weather information from the telematics center includes receiving the weather information in real time during movement toward the destination.

8. The method according to claim 5, further comprising:
transmitting, by the controller, the weather information to a registered mobile terminal when the weather information does not meet the predetermined air pollution standard.

9. A telematics terminal, comprising:
a communication unit configured to receive weather information from a telematics center;
a display unit configured to display the received weather information; and
a controller configured to execute at least one item for triggering a function of purifying air inside a vehicle to be displayed when the weather information does not meet a predetermined air pollution standard.

10. The telematics terminal according to claim 9, wherein the controller is configured to operate the communication unit to automatically transmit a signal to receive the weather information to the telematics center at a specific time after the telematics terminal is turned on.

11. The telematics terminal according to claim 9, wherein, when the at least one item is selected, the controller is configured to operate an air purifier to execute a vehicle air purification function that corresponds to the selected item.

12. The telematics terminal according to claim 11, wherein the item includes at least one of the group consisting of: an item for executing an internal air switch function, an item for executing an air-conditioning function, and an item for executing an air volume control function.

13. The telematics terminal according to claim 9, wherein the controller is configured to operate the display unit to display an item that provides a warning to a user when the weather information does not meet the predetermined air pollution standard.

14. The telematics terminal according to claim 13, wherein the controller is configured to display driving guide information when the weather information does not meet the predetermined air pollution standard and the item that provides the warning to the user is selected.

15. The telematics terminal according to claim 9, wherein the controller is configured to set information regarding a destination based on user input, to transmit the destination information to the telematics center and to provide the weather information, transmitted in real time, to the user in real time when the weather information is provided by the telematics center in real time during movement toward the destination.

16. The telematics terminal according to claim 13, wherein the controller is configured to transmit the weather information to a registered mobile terminal when the weather information does not meet the predetermined air pollution standard.

17. A non-transitory recording medium storing a program for executing a method for controlling a telematics terminal, the method for controlling the telematics terminal comprising:
program instructions that receive weather information from a telematics center;
program instructions that display the received weather information; and
program instructions that display at least one item for triggering a function of purifying air inside a vehicle when the weather information does not meet a predetermined air pollution standard.

18. The non-transitory recording medium of claim 17, further comprising:
program instructions that automatically transmit a signal to receive the weather information to the telematics center at a specific time after the telematics terminal is turned on.

19. The non-transitory recording medium according to claim 17, further comprising:
program instructions that operate an air purifier to execute a vehicle air purification function that corresponds to the at least one item for triggering the function of purifying air inside the vehicle upon selection of the at least one item.

20. The non-transitory recording medium according to claim 19, wherein the item includes at least one of the group consisting of: an item for executing an internal air switch function, an item for executing an air-conditioning function, and an item for executing an air volume control function.
